(19) United States
(12) Patent Application Publication
(10) Pub. No.: US 2011/0100565 A1
(43) Pub. Date: May 5, 2011

(54) SELF-LOCKING COUPLING ELEMENT BETWEEN SHUTTER SLATS

(76) Inventors: Luis Francisco Asensi Alonso, Benetuser (ES); M'Carmen Borderia Monterde, Valencla (ES)

(21) Appl. No.: 12/989,285

(22) PCT Filed: Apr. 14, 2009
(86) PCT No.: PCT/ES2009/070100

§ 371 Date: Oct. 22, 2010

(30) Foreign Application Priority Data
Apr. 14, 2008 (ES) P200801054

(51) Int. Cl. E06B 9/32

(52) U.S. Cl. 160/175

(57) ABSTRACT

The invention relates to a self-locking coupling element between shutter slats, which has been designed to lock the shutter and prevent same from being opened from the exterior. The ends of the coupling element can be inserted into the ends of the slats. The sides of the slats and of the coupling element can be positioned inside a side shutter guide, such that, when an attempt is made to lift the shutter, the upper and lower ends of the coupling element can rotate in relation to the ends of the slats and become locked in the guides, preventing the shutter from being lifted. The invention is characterized in that the coupling element includes a locking projection which becomes locked in the side guide when an attempt is made to lift the shutter, thereby preventing same. In addition, the invention also includes a coupling end that can be engaged in the adjacent slat.

### CROSS-REFERENCE TO RELATED APPLICATIONS

This application is a National Stage of International Application No. PCT/ES20091070100, filed Apr. 14, 2009. This application claims the benefit and priority of Spanish Application No. 200801054, filed Apr. 14, 2008. The entire disclosure of each of the above applications is incorporated herein by reference.

### OBJECT OF THE INVENTION

The present invention relates to a self-locking coupling element between shutter slats, which has been specially designed to lock the shutter before attempts to open it from the exterior.

The ends of the coupling element can be inserted into the ends of the slats. The sides of the slats and of the coupling element can be positioned inside a side shutter guide, such that, when an attempt is made to lift the shutter from its lower part, the upper and lower ends of the coupling element can rotate in relation to the ends of the slats and become locked in the side guides, preventing the shutter from being lifted.

The invention is characterized in that the coupling element includes a locking projection which becomes locked in the side guide when an attempt is made to lift the shutter, thereby preventing same. In addition, it also includes a coupling end that can be engaged in the adjacent slat.

### BACKGROUND OF THE INVENTION

As is known, there are various types of self-locking shutters, which utilize slats and coupling elements constituting mechanisms that prevent the shutter from being unintentionally opened.

The self-locking element object of the invention performs an effective lock while includes means for engaging in an adjacent slat. Thus, when an attempt is made to open the shutter by exerting an upward force from the lower part thereof, the coupling element rotates loosing the verticality and in turn becomes locked in the guide, together with an engagement in the adjacent slat.

The use of coupling elements object of the invention can make up the entire shutter or sections thereof, being adapted to shutters already installed that do not have self-locking characteristics.

In the state of the art different coupling elements between shutter slats which could assist in locking the shutter slats but do not incorporate light, ventilation features, and are not suitable for any type of guide are known. These documents are the utility model ES 10518480, and the document WO02075095 A.

### DESCRIPTION OF THE INVENTION

The invention relates to a self-locking coupling element between shutter slats. This element is specially designed to lock the shutter when an attempt, intended to try accessing to the interior of a room wherein the shutter is, are made to open it from the exterior

The coupling element includes the ends that can be inserted into the ends of the slats. Normally the slats will be positioned above and below the coupling element object of the invention.

The sides of both slats and coupling element are inserted inside side shutter guides. Thus, when an attempt is made to lift the shutter from its lower part, the upper and lower ends of the coupling element rotate in relation to the ends of the slats since the guide has enough clearance as for allowing the rotation thereof.

The invention is characterized in that the coupling element includes a locking projection which becomes locked in the side guide when the mentioned attempt is made to lift the shutter, thereby preventing same.

In addition, it also includes a coupling end to the slat that can be engaged therein.

In this way self-locking is provided by the wedged rotation of the coupling element inside the cavities of the upper and lower slats.

When lowering or lifting the shutter there is no force acting from the lower zone, slats and coupling elements are coupled, with a vertical orientation and have no contact with the profiles of the side guides, which allows upward, folding, downward, unfolding without contact with the side guide movements to be carried out by the shutter.

### DESCRIPTION OF THE DRAWINGS

The present specification is complemented with some planes for illustrating and not limiting the preferred example of the invention.

FIG. 1 is a schematic view of a vertical section of an embodiment of the connecting element.

FIG. 2 is a schematic perspective view of the connecting element corresponding to FIG. 1.

FIG. 3 is a schematic view of an embodiment of a vertical section of an embodiment of the connecting element and upper and lower slats in a side shutter guide.

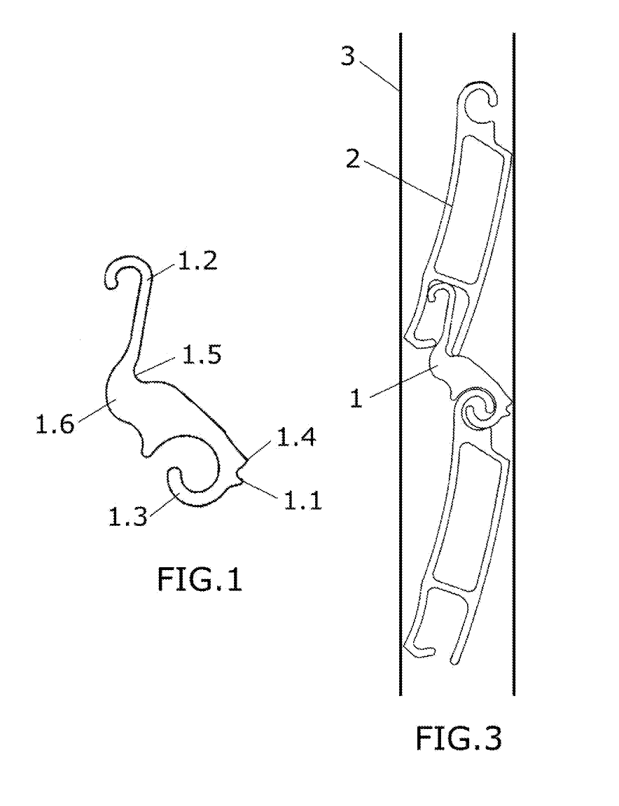

### PREFERRED EMBODIMENT OF THE INVENTION

The self-locking coupling element between shutter slats, includes the ends (1.2, 1.3) that can be inserted in the antagonist ends of the slats (2), normally positioned above and below the coupling element (1).

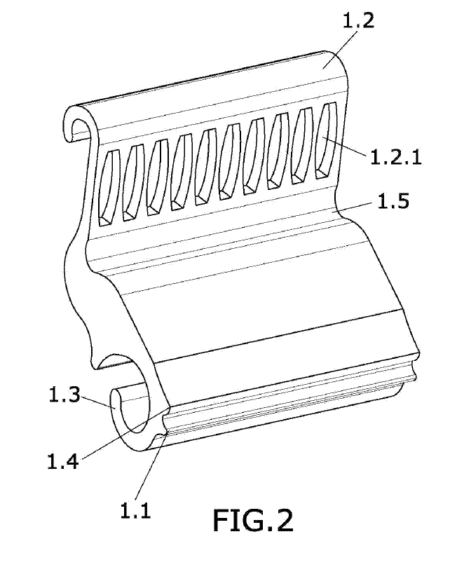

The coupling element (1) includes a locking projection (1.1) in the side guide (3). It further includes one of its ends (1.2) that can be engaged in the adjacent slat (2), which in the case shown in FIG. 3, would be the upper slat.

The engageable end (1.2) can be blind or include means for the light passage. If it includes means for light passage, the light passage is allowed when the engageable end (1.2) of the coupling element (1) is free and not inserted in the adjacent slat (2), whereas the light passage is prevented when it is engaged in the adjacent slat (2). Therefore, the user is allowed to adjust the amount of light and/or ventilation that he/she wants to traverse across the shutter, being able to choose between total darkness, or, even if the shutter is lowered, the light can pass through the passing means thereof positioned at the end (1.2) of the coupling element (1).

By also having the coupling element (1) at least one projection (1.1) for performing the locking in the case an attempt is made to open the shutter from its lower part, this element (1) allows having a self-locking shutter with adjustable light passage.

These means for the light passage of the engageable end (1.2) can, see FIG. 2, include through holes (1.2.1) at said engageable end (1.2).

The self-locking coupling element (1) includes a concave portion (1.5) wherein the end of the slat (2) is housed once the rotation of the coupling element (1) has been completed, which prevents the engageable end (1.2) from become deformed by the shutter weight.

The coupling element (1) may include a second projection (1.4) following the first locking projection (1.1). Thus the coupling element (1) can be suitable for several width dimensions of the side guides (3) since if the first projection (1.1) does not make contact with the guide (3), the second (1.4) would do. It may also be possible the existence of more than two projections.

The lower end (1.3) of the coupling element (1) has a suitable form allowing the rotation in relation to the upper end of the lower slat (2). Thus the profile can perform the dual function of blocking and engaging.

The coupling element has a central body (1.6) that can be blind or has one or more gaps such that it is possible to insert slat anti-sliding elements.

1. Self-locking coupling element between shutter slats, including the ends (1.2, 1.3) that can be inserted in the antagonist ends of the slats (1), their sides being insertable inside shutter guides (3), such that, the ends (1.2, 1.3) of the coupling element (1) can rotate in relation to the ends of the slats (2), characterized in that it comprises having a locking projection (1.1) in the side guide (3), characterized in that it includes and comprising an end (1.2) that can be linearly engaged in the adjacent slat (2), and which additionally has:
a second projection (1.4) following the first protection,
a concave portion (1.5) for housing the end of the slat (2) once the linear engagement of the end (1.2) with the coupling element has been performed and,
a central body (1.6) arranged as a projection.

2. Self-locking coupling element between shutter slats defined in claim 1, characterized in that the engageable end (1.2) is blind.

3. Self-locking coupling element between shutter slats, defined in claim 1, characterized in that the engageable end (1.2) includes means for the light passage.

4. Self-locking coupling element between shutter slats, defined in claim 3, characterized in that the means for the light passage of the engageable end (1.2) include through holes (1.2.1) at said engageable end (1.2).

5. (canceled)

6. (canceled)

7. Self-locking coupling element between shutter slats, defined in claim 1, characterized in that it comprises more than two projections.

8. Self-locking coupling element between shutter slats, defined in claim 1, characterized in that the central body (1.6) can either be blind or has one or more gaps such that it can be possible to insert slat anti-sliding elements.
